(19) United States
(12) Patent Application Publication
(10) Pub. No.: US 2012/0242941 A1
(43) Pub. Date: Sep. 27, 2012

(54) LIQUID CRYSTAL DISPLAY DEVICE AND METHOD FOR MANUFACTURING THE SAME

(75) Inventors: Shunichi Suwa, Kanagawa (JP); Masashi Miyakawa, Kanagawa (JP); Masahiko Nakamura, Kanagawa (JP); Tadaaki Isozaki, Kanagawa (JP)

(73) Assignee: Sony Corporation, Tokyo (JP)

(21) Appl. No.: 13/417,354

(22) Filed: Mar. 12, 2012

(30) Foreign Application Priority Data
Mar. 23, 2011 (JP) 2011-063674

(51) Int. Cl. G02F 1/1337; H01J 9/26

(52) U.S. Cl. 349/123; 445/25

(57) ABSTRACT

A liquid crystal display device includes: a first and a second substrate; and pixels having first electrodes provided on the first substrate which face the second substrate; first alignment control sections provided in the first electrodes; a first alignment film covering the first electrodes, the first alignment control sections, and the first substrate; second electrodes provided on the second substrate which face the first substrate; second alignment control sections provided in the second electrodes; a second alignment film covering the second electrodes, the second alignment control sections, and the second substrate; and a liquid crystal layer provided between the first and the second alignment films and containing liquid crystal molecules. In the above device, the liquid crystal layer further contains a polymerized high molecular compound, and pretilts are provided to the liquid crystal molecules by the polymerized high molecular compound in contact with the alignment films.

### BACKGROUND

The present disclosure relates to a liquid crystal display device including a liquid crystal display element in which a liquid crystal layer is sealed between a pair of substrates having respective alignment films on their facing surfaces and a method for manufacturing the liquid crystal display device.

In recent years, as display monitors of liquid crystal televisions, notebook personal computers, car navigation devices, and the like, many liquid crystal displays (LCD) have been frequently used. This liquid crystal displays are classified into various display modes (methods) in accordance with molecular arrangement (alignment) of liquid crystal molecules contained in a liquid crystal layer provided between substrates. As a display mode, for example, a TN (Twisted Nematic) mode in which liquid crystal molecules are twisted to be aligned in a state in which no voltage is applied has been very common. In the TN mode, liquid crystal molecules each have positive dielectric anisotropy, that is, the dielectric constant of each liquid crystal molecule in a long-axis direction is higher than that in a short-axis direction thereof. Therefore, the liquid crystal molecules are configured to be aligned in a direction perpendicular to a substrate surface in a plane parallel to the substrate surface while the alignment directions of the liquid crystal molecules are sequentially rotated.

On the other hand, a VA (Vertical Alignment) mode in which liquid crystal molecules are aligned perpendicularly to a substrate surface in a state in which no voltage is applied attracts increasing attention. In the VA mode, liquid crystal molecules each have negative dielectric anisotropy, that is, the dielectric constant of each liquid crystal molecule in a long-axis direction is lower than that in a short-axis direction thereof, and a wider viewing angle than that in the TN mode can be realized.

The VA mode liquid crystal display as described above has the structure in which when a voltage is applied, liquid crystal molecules aligned in a direction perpendicular to a substrate respond so as to go down in a direction parallel to the substrate due to the negative dielectric anisotropy, thereby allowing light to pass therethrough. However, since the liquid crystal molecules aligned in a direction perpendicular to the substrate each may go down in an arbitrary direction, the alignment of the liquid crystal molecules is disordered by the voltage application, and hence, response properties with respect to voltage are degraded thereby.

Therefore, in order to improve the response properties, a technique of limiting a direction in which liquid crystal molecules go down in response to voltage application has been studied. In particular, for example, there may be mentioned a technique (photo-alignment technique) of providing pretilt angles to liquid crystal molecules by using an alignment film formed by irradiating linearly polarized ultraviolet light in an oblique direction with respect to a substrate surface. As the photo-alignment technique, for example, there has been a technique of forming an alignment film by irradiating linearly polarized ultraviolet light in an oblique direction with respect to a substrate surface to a film formed of a polymer containing a chalcone structure to cross-link a double bond portion therein (see Japanese Unexamined Patent Application publication Nos. 10-087859, 10-252646, and 2002-082336). In addition, besides the above technique, there has been a technique of forming an alignment film by using a mixture of a vinyl cinnamate derivative polymer and a polyimide (see Japanese Unexamined Patent Application publication No. 10-232400). Furthermore, for example, there has also been a technique of forming an alignment film by irradiating linearly polarized light having a wavelength of 254 nm to a film containing a polyimide to decompose part thereof (see Japanese Unexamined Patent Application publication No. 10-073821). Moreover, as a peripheral technique related to the photo-alignment technique, there has been a technique of forming a liquid crystal alignment film by forming a film made of a liquid crystal polymer compound on a film of a polymer containing a dichromatic photoreactive structural unit, such as an azobenzene derivative, irradiated with linearly polarized light or oblique light (see Japanese Unexamined Patent Application publication No. 11-326638).

### SUMMARY

However, in the photo-alignment technique described above, although the response properties are improved as compared to that of a related MVA mode and PVA mode, there has been a problem in that, when an alignment film is formed, a large-scale light irradiation apparatus such as an apparatus of irradiating linearly polarized light in an oblique direction with respect to a substrate surface may be necessary. Furthermore, when a liquid crystal display having multi-domains in which alignment of liquid crystal molecules is divided by providing a plurality of sub-pixels in a pixel is manufactured in order to realize a wider viewing angle, besides the above problem in that a larger-scale apparatus is necessary, the manufacturing process is disadvantageously complicated. In particular, in the liquid crystal display having multi-domains, an alignment film is formed so as to provide different pretilts to respective sub-pixels. Therefore, when the photo-alignment technique described above is used to manufacture a liquid crystal display having multi-domains, since light is to be irradiated to respective sub-pixels, mask patterns for the respective sub-pixels are necessary, and the scale of a light irradiation apparatus is, furthermore, inevitably increased.

Therefore, it is desirable to provide a liquid crystal display device which can easily improve response properties without using any large-scale apparatus and a method for manufacturing the liquid crystal display device.

According to an embodiment of the present disclosure, there is provided a liquid crystal display device including: a first substrate; a second substrate; and a plurality of arranged pixels which includes: first electrodes provided on a facing surface of the first substrate facing the second substrate; first alignment control sections provided in the first electrodes; a first alignment film covering the first electrodes, the first alignment control sections, and the facing surface of the first substrate; second electrodes provided on a facing surface of the second substrate facing the first substrate; second alignment control sections provided in the second electrodes; a second alignment film covering the second electrodes, the second alignment control sections, and the facing surface of the second substrate; and a liquid crystal layer which is provided between the first alignment film and the second alignment film and which contains liquid crystal molecules. In the above liquid crystal display device, the liquid crystal layer further contains a polymerized high molecular compound (hereinafter, referred to as a “high molecular polymer compound” in some cases), and the polymerized high molecular compound (high molecular polymer compound) in contact with the alignment films provides pretilts to the liquid crystal molecules.

According to an embodiment of the present disclosure, there is provided a method for manufacturing a liquid crystal display device (including a method for manufacturing a liquid crystal display element, and hereinafter, this method is included in the method for manufacturing a liquid crystal display device as described above) which has a first substrate; a second substrate; and a plurality of arranged pixels including: first electrodes provided on a facing surface of the first substrate facing the second substrate; first alignment control sections provided in the first electrodes; a first alignment film covering the first electrodes, the first alignment control sections, and the facing surface of the first substrate; second electrodes provided on a facing surface of the second substrate facing the first substrate; second alignment control sections provided in the second electrodes; a second alignment film covering the second electrodes, the second alignment control sections, and the facing surface of the second substrate; and a liquid crystal layer which is provided between the first alignment film and the second alignment film and which contains liquid crystal molecules. The method for manufacturing a liquid crystal display device described above includes: forming the first alignment film on the first substrate; forming the second alignment film on the second substrate; arranging the first substrate and the second substrate so that the first alignment film and the second alignment film face each other; sealing a pre-liquid crystal layer between the first alignment film and the second alignment film, the pre-liquid crystal layer containing the liquid crystal molecules and a polymerizable compound (a polymerizable low molecular compound or a polymerizable high molecular compound, and hereinafter referred to as an “unpolymerized compound” in some cases); and polymerizing the compound (unpolymerized compound) to form the liquid crystal layer from the pre-liquid crystal layer and to provide pretilts to the liquid crystal molecules.

In the method for manufacturing a liquid crystal display device according to an embodiment of the present disclosure, by applying a predetermined electric field to the pre-liquid crystal layer, while the liquid crystal molecules are aligned, the compound (unpolymerized compound) can be polymerized by irradiation of energy rays, or by applying a predetermined electric field to the pre-liquid crystal layer, while the liquid crystal molecules are aligned, the compound (unpolymerized compound) can be polymerized by heating. In this case, for example, ultraviolet rays, X-rays, and electron rays may be mentioned as the energy rays.

In the liquid crystal display device or the method for manufacturing a liquid crystal device according to the preferred form of the present disclosure, in a central region of an overlapping area in each pixel in which a projection image of a region surrounded by a border of the first electrode and the first alignment control section and a projection image of a region surrounded by a border of the second electrode and the second alignment control section are overlapped with each other, the long axes of a liquid crystal molecular group in the liquid crystal layer can be located approximately in the same imaginary plane. In this case, when the central region of the overlapping area is viewed along a normal direction of the second substrate, the long axes of a liquid crystal molecular group which occupies the central region of the overlapping area along the normal direction of the second substrate (in more particular, a liquid crystal molecular group which occupies a minute columnar region from the first substrate to the second substrate) are located approximately in the same imaginary direction.

The “central region of the overlapping area” indicates a region having the center which coincides with the center of the overlapping area, a shape similar to that of the overlapping area, and an area corresponding to 25% of that of the overlapping area. In addition, “the long axes of a liquid crystal molecular group in the liquid crystal layer are located approximately in the same imaginary plane” indicates that angles formed between the imaginary plane and the long axes of the liquid crystal molecular group are within ±5°. In other words, the variation in azimuth angle (deviation angle) of the liquid crystal molecular group is within ±5°. Furthermore, when the pixel is formed of a plurality of sub-pixels, the sub-pixels each may be regarded as the pixel.

As described above, in the central region of the overlapping area in each pixel described above, since the long axes of the liquid crystal molecular group in the liquid crystal layer are located approximately in the same imaginary plane, that is, since in the central region of the overlapping area, the liquid crystal molecular group in the liquid crystal layer is not in the state (twisted state) in which the long axes of the liquid crystal molecular group are twisted from one electrode side to the other electrode side, when a voltage is applied between a pair of the electrodes, no time is necessary to eliminate the twist of the long axes of the liquid crystal molecular group, and response can be performed in the same plane, thereby further improving the response properties.

Incidentally, as a method for measuring the variation in angle formed between the imaginary plane and the long axes of the liquid crystal molecular group and/or the variation in azimuth angle (deviation angle) of the liquid crystal molecular group, for example, an attenuated total reflectance vibration method (also called an attenuated total reflectance method) or a retardation measurement method may be mentioned. The attenuated total reflectance vibration method is a method for measuring an absorption spectrum of a sample surface, and in this method, after a sample is adhered to a high-refractive-index medium (prism), total reflected light which slightly oozes therefrom and is reflected is measured. In addition, in this method, by rotating the direction of this sample, information (alignment direction) of absorption of molecules in the vicinity of approximately 100 nm from the interface between the liquid crystal and the alignment film is obtained. In addition, the retardation measurement method is a method in which after the retardation is measured by RETS100 (manufactured by Otsuka Electronics Co., Ltd.) in the state in which a liquid crystal cell is inclined at a desired angle, and the retardation in an ideal alignment state in which a pretilt is provided is calculated in advance, fitting is performed so as to obtain the pretilt by calculation. In addition, by rotating the sample in a sample plane, an azimuth angle provided with a pretilt can be obtained.

In the liquid crystal display device or the method for manufacturing a liquid crystal device according to the above preferred form of the present disclosure, the liquid crystal molecules may be configured to have negative dielectric anisotropy.

Furthermore, in the liquid crystal display device or the method for manufacturing a liquid crystal device according to the above preferred form and structure of the present disclosure, the high molecular compound may be formed from a high molecular compound containing at least one selected from an acrylic group, a methacrylic group, a vinyl group, a vinyloxy group, a propenyl ether group, an epoxy group, an oxetane group, and styryl group, or the high molecular compound (high molecular polymer compound) may be formed from a high molecular compound having a mesogenic group.

A general formula of the unpolymerized compound is shown below.

A¹-S¹-P¹-(S²-P²)ₙ-S³-A² (1)

The group A¹ and the group A² are the same polymerizable functional group or different polymerizable functional groups. In particular, for example, there may be mentioned a radical group; a group suitable for a polymerization reaction, such as ionic polymerization, polyaddition, or polycondensation; a group which is suitable for a polymer similar reaction, such as addition to or condensation with a polymer main chain, which is preferably for chain polymerization, and in particular, which is a group having a C═C double bond or a C≡C triple bond; and a group suitable for ring opening polymerization of an oxetane group, an epoxide group, or the like.

In more particular, as the group A¹ or A², for example, there may be mentioned a functional group selected from the group consisting of

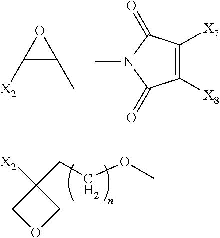

CH₂═CX₁—COO—, CH₂═CX₁—CO—, CH₂═CX₂—(O)ₙ—, CX₁═CH—CO—(O)ₙ—, CX₁═CH—CO—NH—, CH₂═CX₁—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)2N—CO—, HO—CX₂X₃—, HS—CX₂X₃—, HX₂N—, HO—CX₂X₃—NH—, CH₂═CH—(COO)ₙ-Ph-(O)ₙ—, CH₂═CH—(CO)ₙ—, Ph-(O)ₙ—, Ph-CH═CH—, HOOC—, OCN—, and X₄X₅X₆Si—.

In addition, X₁ represents H, F, Cl, CN, CF₂, a phenyl group, or an alkyl group having 1 to 5 carbon atoms and particularly preferably represents H, F, Cl, or a methyl group.

X₂ and X₃ each independently represent H or an alkyl group having 1 to 5 carbon atoms and particularly preferably represents H, a methyl group, an ethyl group, or an n-propyl group.

X₄, X₅, and X₆ each independently represent Cl, an oxaalkyl group having 1 to 5 carbon atoms, or an oxacarbonyl alkyl group having 1 to 5 carbon atoms.

X₇ and X₈ each independently represent H, Cl, or an alkyl group having 1 to 5 carbon atoms.

Ph represents a phenyl ring or a phenyl ring which is substituted with at least one of F, Cl, and CN, and/or with at least one of an alkyl group, an alkoxy group, an alkenyl group, an alkynyl group, an alkylcarbonyl group, an alkoxycarbonyl group, alkylcarbonyloxy group, or alkoxycarbonyloxy group, each of which has a straight or a branched chain having 1 to 12 carbon atoms and may be substituted with at least one fluorine atom.

In addition, n represents 0 or 1.

The group S¹ and the group S³ each function as a spacer and are each selected from formulas S′-X′ so that “S” of the group A-S— of the above formula (I) corresponds to one of the formulas S′-X′.

In this case, S′ represents an alkylene group having 1 to 20 carbon atoms and preferably 1 to 12 carbon atoms, and the alkylene group may be substituted with at least one of F, Cl, Br, I, or CN. In addition, besides the above conditions, one or two or more —CH₂—, which are not adjacent to each other, may be independently substituted with —O—, —S—, —NH—, —NR₀—, —SiR₁R₂—, —CO—, —COO—, —COO—, —COO—O—, —S—CO—, —CO—S—, —NR₂—CO—O—, —O—CO—NR₂—, —NR₂—CO—NR₂—, —CH═CH—, or —C≡C— so that O atoms and/or S atoms are not directly bonded to each other.

X′ represents —O—, —S—, —CO—, —COO—, —COO—, —O—COO—, —CO—NR₂—, —NR₂—CO—, —NR₂—CO—NR₂—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR₀—, —CY₂═CY₃—, —C≡C—, —CH═CH—COO—, —OC O—CH═CH—, or a single bond.

In this case, R₀, R₁, and R₂ each independently represent H or an alkyl group having 1 to 12 carbon atoms.

In addition, Y₂ and Y₃ each independently represent H, F, Cl, or CN.

The group S² also functions as a spacer and represents —O—, —S—, —CO—, —CO—O—, —COO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—COO—, —OCO—CH═CH—, —CR₁R₂—, or a single bond, and when a plurality of the groups S² is used, the same group or different groups may be arbitrarily selected from the above. In addition, R₁ and R₂ each independently represent H or an alkyl group having 1 to 12 carbon atoms, and n1 represents 1, 2, 3, or 4.

The group P¹ and the group P² each independently represent an aromatic group, a heteroaromatic group, an alicyclic group, or a heterocyclic group, each of which has 4 to 25 ring atoms, may contain a condensed ring, and may be substituted with at least one of the group A-S—, H, OH, CH₂OH, a halogen, SF_{S}, NO₂, a carbon group, or a hydrocarbon group. In addition, the group P¹ and the group P² more preferably represent 1,4-phenylene (at least one —CH— may be substituted with N), naphthalene-1,4-diyl (at least one —CH— may be substituted with N), naphthalene-2,6-diyl (at least one —CH— may be substituted with N), phenanthrene 2,7-diyl (at least one —CH— may be substituted with N), anthracene-2,7-diyl (at least one —CH— may be substituted with N), fluorene-2,7-diyl (at least one —CH— may be substituted with N), coumarin (at least one —CH— may be substituted with N), flavone (at least one —CH— may be substituted with N), cyclohexane-1,4-diyl (one or two or more —CH₂—, which are not adjacent to each other, may be substituted with O and/or S),1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indan-2,5-diyl, or octahydro-4,7-methanoindan-2,5-diyl. However, all the groups mentioned above may not be substituted or may be substituted with at least one of substituents mentioned below. As the substituents, there may be mentioned the group A, the group A-S—, OH, CH₂OH, F, Cl, Br, I, —CN, —NO₂, —NCO, —NCS, —OCN, —SCN, —C(═O)N(Rₓ)₂, —C(═O)Y₁, —C(═O)Rₓ, —N(Rx)₂, a silyl group which may be substituted, an aryl group which has 6 to 20 carbon atoms and which may be substituted, or one of an alkyl group, an alkoxy group, an alkylcarbonyl group, an alkoxycarbonyl group, an alkylcarbonyloxy group, and an alkoxycarbonyloxy group, each of which is a straight or a branched group having 1 to 25 carbon atoms. However, in addition, at least one H atom may be substituted with F, Cl, P, or the group A-S. In addition, the group A represents one of the group A¹ and the group A², and the group S represents one of the group S1, the group S2, and the group S3.

Y₁ represents a halogen.

Rₓ represents the group A, the group A-S—, H, a halogen, a straight, branched, or cyclic alkyl group having 1 to 25 carbon atoms (however, in addition, one or two or more —CH₂—, which are not adjacent to each other, may be substituted with —O—, —S—, —CO—. —COO—, —O—CO—, and/or —O—CO—O— so that O atoms and/or S atoms are not directly bonded to each other, and/or at least one H atom may be substituted with F, Cl, P, or the group A-S—), an aryl group or an aryloxy group, each of which may be substituted and which has 6 to 40 carbon atoms, or a heteroaryl group or a heteroaryloxy group, each of which may be substituted and which has 2 to 40 carbon atoms.

In particular, as the unpolymerized compound, the following compounds may be mentioned by way of example.

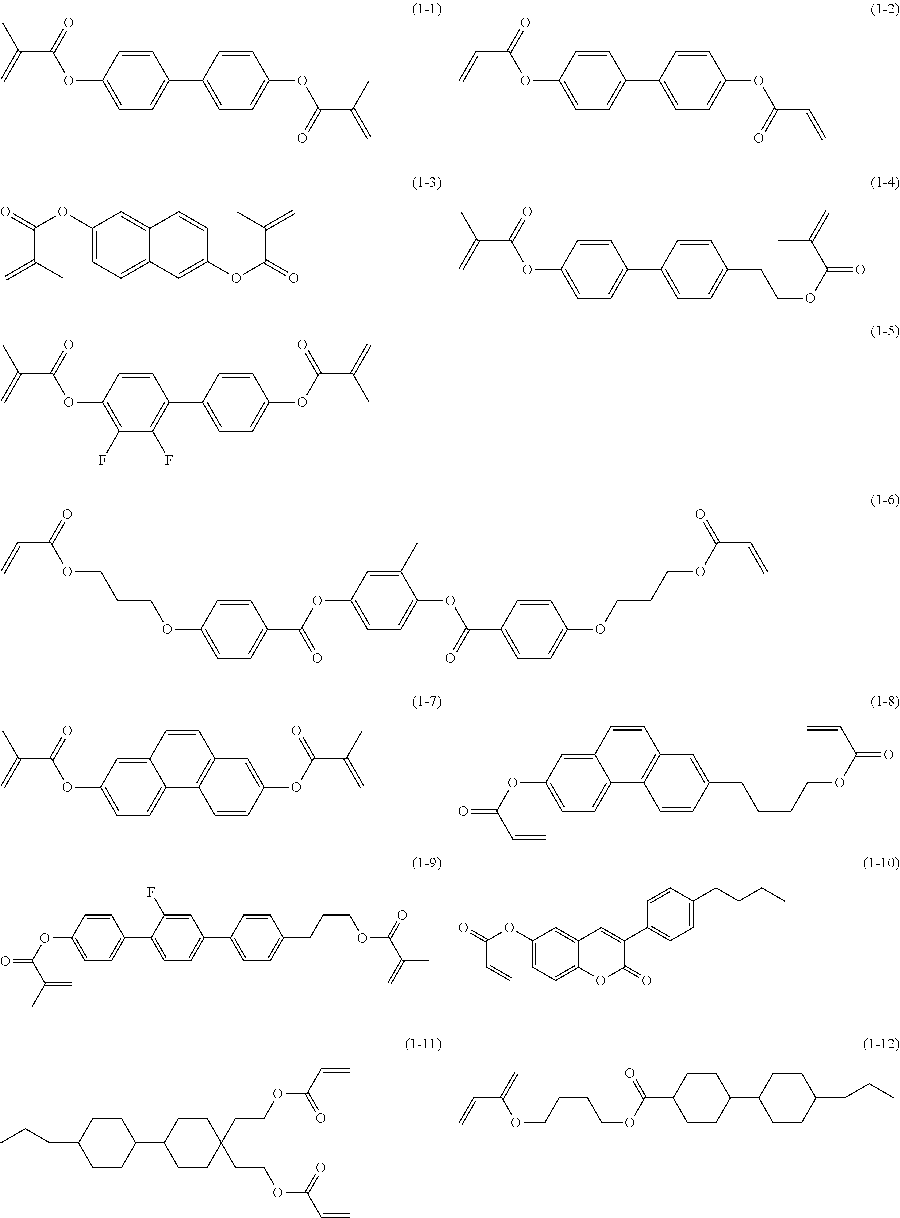

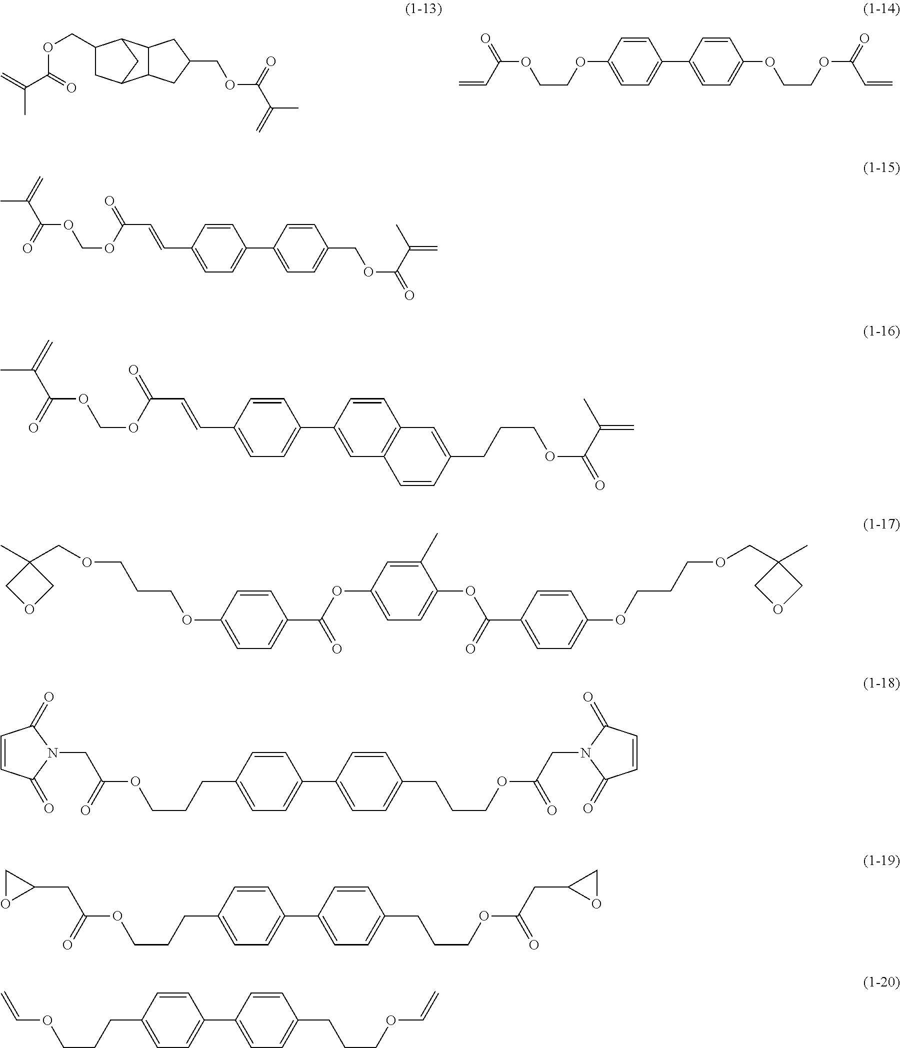

A material forming the first alignment film and the second alignment film may be appropriately selected from common materials used for forming a vertical alignment film.

In the liquid crystal display device or the method for manufacturing a liquid crystal device according to the above preferred form and structure of the present disclosure (hereinafter, these may be collectively called simply the “present disclosure” in some cases), the first alignment film and the second alignment film can be configured to have a surface roughness Ra of 1 nm or less. In this case, the surface roughness Ra is specified by JIS B 0601:2001.

In the present disclosure, the structure can be formed such that the first alignment control sections are first slit portions formed in the first electrode, the second alignment control sections are second slit portions formed in the second electrode, the width of the first slit portion and that of the second slit portion are each in a range of 2 to less than 10 w, and the pitch of the first slit portion and that of the second slit portion are each in a range of 10 for 180 v, preferably in a range of 30 to 180 μm, and more preferably in a range of 60 to 180 μm.

A pair of the substrates is formed of a substrate having pixel electrodes and a substrate having counter electrodes. That is, there may be formed the structure in which the first substrate is used as the substrate having pixel electrode and the second substrate is used as the substrate having counter electrodes or the structure in which the second substrate is used as the substrate having pixel electrode and the first substrate is used as the substrate having counter electrodes. In this case, energy rays are preferably irradiated from a side of the substrate having pixel electrodes. Since a color filter is generally formed at a side of the substrate having counter electrodes, when energy rays are absorbed by this color filter, it may be difficult to polymerize the compound (unpolymerized compound) in some cases; hence, energy rays are preferably irradiated from the side of the substrate having pixel electrodes on which no color filter is formed. In addition, when the color filter is formed at the side of the substrate having pixel electrodes, energy rays may be irradiated from the side of the substrate having a color filter.

Although the high molecular compound (high molecular polymer compound) aligns liquid crystal molecules in a predetermined direction with respect to the pair of the substrate, that is, with respect not only to the first substrate but also to the second substrate, a first pretilt angle θ1 provided to liquid crystal molecules in the vicinity of the first alignment film may be the same as or different from a second pretilt angle θ2 provided to liquid crystal molecules in the vicinity of the second alignment film. Fundamentally, the azimuth angle (deviation angle) of each liquid crystal molecule when a pretilt is provided is specified by the intensity and the direction of the electric field and the composition and the structure of each of the first alignment control section and the second alignment control section, and the polar angle (zenith angle) is specified by the intensity of the electric field. When the first pretilt angle θ1 and the second pretilt angle θ2 are made different from each other, for example, the composition and the structure of the first alignment control section may be made different from those of the second alignment control section.

In the liquid crystal display device and the method for manufacturing the same according to the embodiments of the present disclosure, pretilts are provided to the liquid crystal molecules by the high molecular compound (high molecular polymer compound) in contact with the alignment films, or pretilts are provided to the liquid crystal molecules by polymerizing the compound (unpolymerized compound). In addition, since the compound is polymerized in the state in which the liquid crystal molecules are aligned, without irradiating the alignment films with linearly polarized light or light in an oblique direction before the pre-liquid crystal layer is sealed, and without using a large-scale apparatus, pretilts can be provided to the liquid crystal molecules. Furthermore, since the first alignment control sections and the second alignment control sections are formed in the first electrodes and the second electrodes, respectively, when an electric field is applied between the pixel electrode and the counter electrode, the long axis direction of each liquid crystal molecule responds in a predetermined direction with respect to the substrate surface, and the response speed can be improved, so that excellent display properties can be ensured.

### BRIEF DESCRIPTION OF THE DRAWINGS

FIG. 1 is a schematic partial cross-sectional view of a liquid crystal display device according to an embodiment of the present disclosure;

FIG. 2A is a schematic view of a first electrode, first slit portions, a second electrode, and second slit portions when one pixel is viewed from the above;

FIG. 2B is a schematic view of the second electrode and the second slit portions when one pixel is viewed from the above;

FIG. 3A is a schematic view of a modification of the first electrode, the first slit portions, the second electrode, and the second slit portions when one pixel is viewed from the above;

FIG. 3B is a schematic view of the modification of the second electrode and the second slit portions when one pixel is viewed from the above;

FIG. 4A is a schematic view of another modification of the first electrode, the first slit portions, the second electrode, and the second slit portions when one pixel is viewed from the above;

FIG. 4B is a schematic view of the another modification of the second electrode and the second slit portions when one pixel is viewed from the above;

FIGS. 5A and 5B are schematic views each showing a twisted state of long axes of a liquid crystal molecular group;

FIG. 6 is a schematic view illustrating a pretilt of a liquid crystal molecule;

FIG. 7 is a schematic partial cross-sectional view of substrates and the like illustrating a method for manufacturing the liquid crystal display device shown in FIG. 1;

FIG. 8 is a schematic partial cross-sectional view of the substrates and the like illustrating a step following the step shown in FIG. 7;

FIG. 9 is a schematic partial cross-sectional view of the substrates and the like illustrating a step following the step shown in FIG. 8;

FIG. 10 is a circuit configuration diagram of the liquid crystal display device shown in FIG. 1;

FIG. 11 is a schematic cross-sectional view illustrating an order parameter; and

FIG. 12 is a schematic view of a first electrode of a liquid crystal display device of Comparative Example 1.

### DETAILED DESCRIPTION OF EMBODIMENTS

Hereinafter, with reference to the drawings, the present disclosure will be described using embodiments and examples; however, the present disclosure is not limited thereto, and various values and materials in the embodiments and the examples will be described merely by way of example. In addition, description will be made in the following order.

1. [Description of the common composition and structure of a liquid crystal display device according to an embodiment of the present disclosure]
2. [Description of a liquid crystal display device and a method for manufacturing the same according to an embodiment of the present disclosure]
3. [Description of a liquid crystal display device and a method for manufacturing the same according to an example of the present disclosure, and others]
[Description of the common composition and structure of a liquid crystal display device according to an embodiment of the present disclosure]

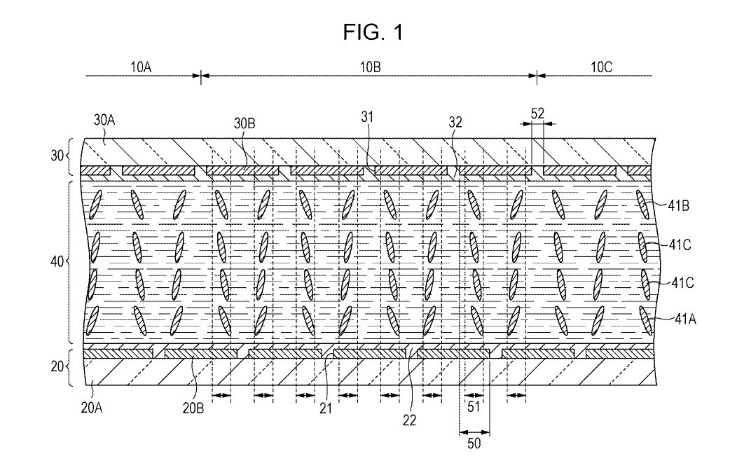

FIG. 1 is a schematic partial cross-sectional view of a liquid crystal display device (or liquid crystal display element) according to an embodiment of the present disclosure. This liquid crystal display device has a plurality of pixels 10 (10A, 10B, 10C, and so on). In addition, in this liquid crystal display device (liquid crystal display element), a liquid crystal layer 40 containing liquid crystal molecules 41 is provided between a thin film transistor (TFT) substrate 20 and a color filter (CF) substrate 30 with alignment films 22 and 32 provided therebetween, respectively. This liquid crystal display device (liquid crystal display element) is a so-called transmission type, and a display mode is a vertical alignment (VA) mode. FIG. 1 shows a non-driving state in which no drive voltage is applied. In addition, the pixels 10 are each actually formed, for example, of a sub-pixel which displays a red image, a sub-pixel which displays a green image, and a sub-pixel which displays a blue image.

In this case, the TFT substrate 20 corresponds to the first substrate, and the CF substrate 30 corresponds to the second substrate. In addition, a pixel electrode 20B and the alignment film 22 provided on the first substrate (TFT substrate) 20 correspond to the first electrode and the first alignment film, respectively, and a counter electrode 30B and the alignment film 32 provided on the second substrate (CF substrate) 30 correspond to the second electrode and the second alignment film, respectively.

That is, this liquid crystal display device includes the first substrate (TFT substrate) 20, the second substrate (CF substrate) 30, and a plurality of the arranged pixels 10 which includes the first electrodes (pixel electrodes) 20B formed on a facing surface of the first substrate 20 facing the second substrate 30, first alignment control sections 21 provided in the first electrodes (pixel electrodes) 20B, the first alignment film 22 covering the first electrodes (pixel electrodes) 20B, the first alignment control sections 21, and the facing surface of the first substrate (TFT substrate) 20, the second electrodes (counter electrodes) 30B formed on a facing surface of the second substrate (CF substrate) 30 facing the first substrate (TFT substrate) 20, second alignment control sections 31 provided in the second electrodes (counter electrodes) 30B, the second alignment film 32 covering the second electrodes (counter electrodes) 30B, the second alignment control sections 31, and the facing surface of the second substrate (CF substrate) 30, and the liquid crystal layer 40 which is provided between the first alignment film 22 and the second alignment film 32 and which contains the liquid crystal molecules 41.

On the surface of the TFT substrate 20 formed of a glass facing the CF substrate 30 formed of a glass, for example, the pixel electrodes 20B are arranged in a matrix. In addition, for example, there are also provided TFT switching elements each having a gate, a source, a drain, and the like which drive the respective pixel electrodes 20B, and gate and source lines which are connected to the TFT switching elements (these elements and lines mentioned above are not shown in the figure). The pixel electrode 20B is provided in each pixel electrically isolated by a pixel isolation portion 52 and is formed of a material, such as indium tin oxide (ITO), having transparency. In each pixel, first slit portions 21 (in each of which no electrode is formed) having a stripe or a v-shaped pattern are provided in the pixel electrode 20B. Hence, when a drive voltage is applied, an electric field oblique to the long axis directions of the liquid crystal molecules 41 is applied, and regions having different alignment directions are formed in the pixel (alignment division); hence, viewing angle properties can be improved. That is, in order to ensure excellent display properties, the first slit portion 21 is the first alignment control section for controlling the alignment of all the liquid crystal molecules 41 in the liquid crystal layer 40, and in this case, by this first slit portion 21, the alignment directions of the liquid crystal molecules 41 at the time of drive voltage application are controlled. As described above, fundamentally, the azimuth angle of each liquid crystal molecule when a pretilt is provided is specified by the intensity and the direction of the electric field and the composition and the structure of each of the first alignment control section 21 and the second alignment control section 31, and the direction of the electric field is determined by the alignment control section.

Almost over the entire surface of an effective display region, the color filter (not shown) formed, for example, of stripe filters of red (R), green (G), and blue (B) and the counter electrodes 30B are arranged on the surface of the CF substrate 30 facing the TFT substrate 20. As in the case of the pixel electrode 20B, for example, the counter electrode 30B is formed of a material, such as ITO, having transparency. In the counter electrode 30B, for example, second slit portions 31 (in each of which no electrode is formed) having a stripe or a v-shaped pattern are provided in each pixel. Accordingly, when a drive voltage is applied, an electric field oblique to the long axis directions of the liquid crystal molecules 41 is applied, and regions having different alignment directions are formed in the pixel (alignment division); hence, viewing angle properties can also be improved. That is, in order to ensure excellent display properties, the second slit portion 31 is the second alignment control section for controlling the alignment of all the liquid crystal molecules 41 in the liquid crystal layer 40, and also in this case, by this second slit portion 31, the alignment directions of the liquid crystal molecules 41 at the time of drive voltage application are also controlled.

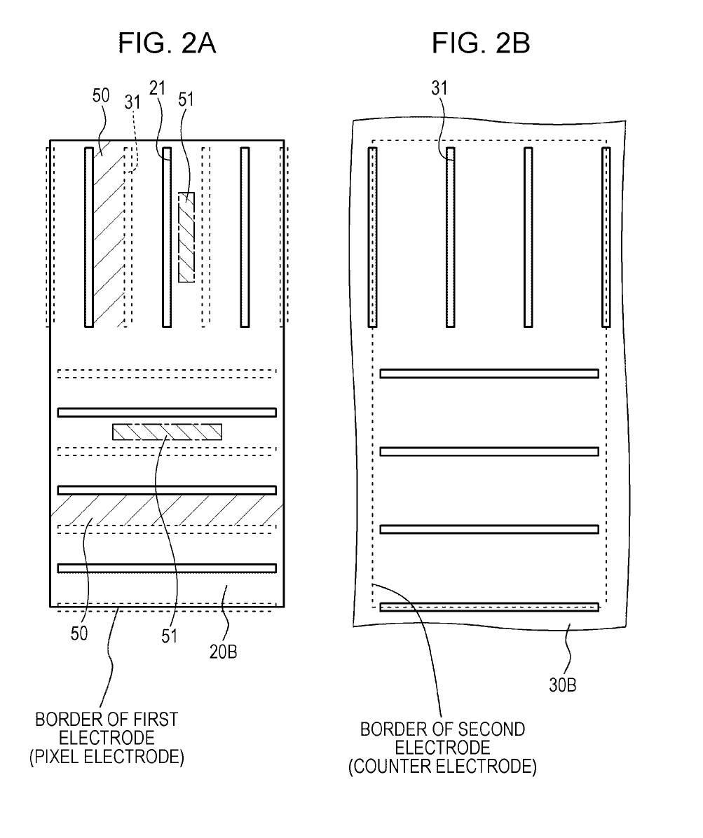

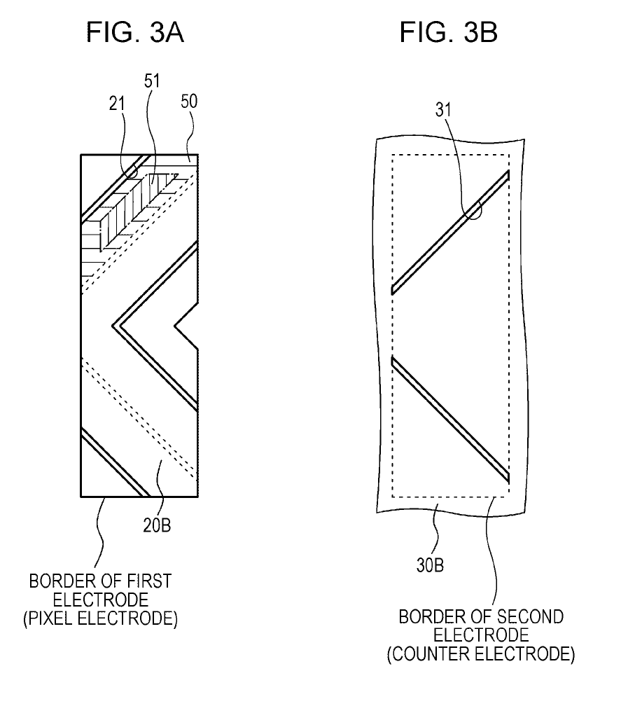

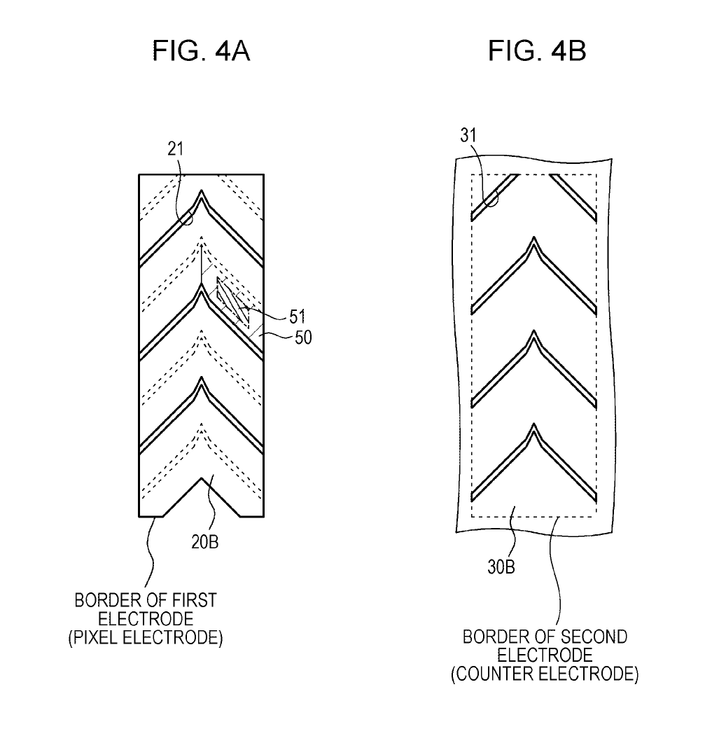

The second slit portion 31 is arranged so as not to face the first slit portion 21 between the substrates. In more particular, the first slit portions 21 are provided parallel to each other, and the second slit portions 31 are also provided parallel to each other. In addition, in one pixel, the first slit portions 21 are extended in two directions which orthogonally intersect each other, and as in the case described above, the second slit portions 31 are extended in two directions which orthogonally intersect each other. In addition, the first slit portions 21 are provided parallel to the second slit portions 31 corresponding to the above first slit portions 21, a projection image of one first slit portion 21 is located on a projection image of a symmetrical line between two second slit portions 31, and a projection image of one second slit portion 31 is located on a projection image of a symmetrical line between two first slit portions 21. Arrangement of the first electrode (pixel electrode) 20B, the first slit portions 21, the second electrode (counter electrode) 30B, and the second slit portions 31 and arrangement of the second electrode (counter electrode) 30B and the second slit portions 31, each of which is obtained when one pixel (sub-pixel) is viewed from the above, are shown in FIGS. 2A and 2B, respectively. In addition, modification examples of the outer shape of the first slit portion 21 and that of the second slit portion 31 are shown in FIGS. 3A and 4A, and modification examples of the outer shape of the second slit portion 31 are shown in FIGS. 3B and 4B. Incidentally, in FIGS. 2A, 3A, and 4A, a border of the first electrode (pixel electrode) 20B and the first alignment control sections (the first slit portions 21) are each shown by a solid line, and the second alignment control sections (the second slit portions 31), each of which is located above, are each shown by a dotted line. In addition, overlapping areas 50 in each of which a projection image of a region surrounded by the border of the first electrode (pixel electrode) 20B and the first alignment control section (the first slit portion 21) and a projection image of an region surrounded by a border of the second electrode (counter electrode) 30B and the second alignment control section (the second slit portion 31) are hatched with oblique lines, and furthermore, central regions 51 are each surrounded by a chain line and also hatched with oblique lines. For the convenience, one overlapping area 50 and one central region 51 are only shown in FIGS. 3A and 4A. In addition, in FIGS. 2B, 3B, and 4B, the border of the second electrode (counter electrode) 30B in each pixel is shown by a dotted line, and the second alignment control sections (the second slit portions 31) are each shown by a solid line. The shape of the first alignment control section (the first slit portion 21) may be replaced by that of the second alignment control section (the second slit portion 31), and the shape of the second alignment control section (the second slit portion 31) may be replaced by that of the first alignment control section (the first slit portion 21).

The first alignment film 22 is provided on the surface of the TFT substrate 20 at a liquid crystal layer 40 side so as to cover the pixel electrodes 20B and the first slit portions 21. The second alignment film 32 is provided on the surface of the CF substrate 30 at the liquid crystal layer 40 side so as to cover the counter electrodes 30B.

The alignment films 22 and 32 control an initial alignment state of the liquid crystal molecules 41 and has a function not only to align the liquid crystal molecules 41 in a direction perpendicular to the substrate surface but also, before a compound (unpolymerized compound) contained in a pre-liquid crystal layer (which will be described later) is polymerized, to align liquid crystal molecules 41 (41A and 41B) in the vicinities of the substrates in a direction perpendicular to the substrate surface.

In this case, in particular, the width of the first slit portion 21 and that of the second slit portion 31 are each 5 μm, and the pitch of the first slit portion 21 and that of the second slit portion 31 are each 113 μm.

In addition, in each pixel (sub-pixel), in the central region of the overlapping area in which the projection image of the region surrounded by the border of the first electrode (pixel electrode) 20B and the first alignment control section (first slit portion 21) and the projection image of the region surrounded by the border of the second electrode (counter electrode) 30B and the second alignment control section (the second slit portion 31) are overlapped with each other, the long axes of a liquid crystal molecular group in the liquid crystal layer 40 are located approximately in the same imaginary plane. That is, the variation in azimuth angle (deviation angle) of the liquid crystal molecular group in the liquid crystal layer 40 is within ±5°.

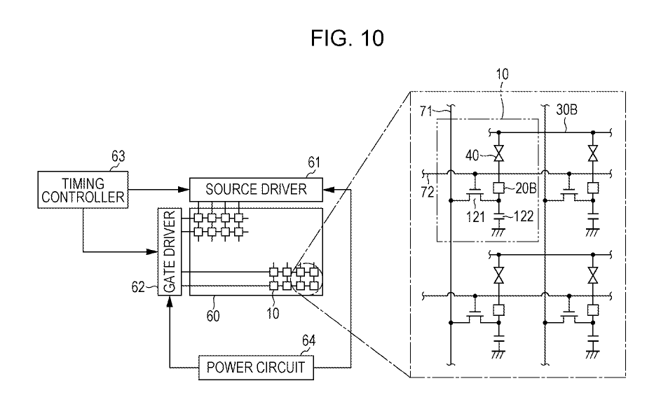

FIG. 10 is a circuit configuration diagram of the liquid crystal display device shown in FIG. 1.

As shown in FIG. 10, the liquid crystal display device is formed to include a liquid crystal display element having the pixels 10 provided in a display region 60. In this liquid crystal display device, along the periphery of the display region 60, there are provided a source driver 61 and a gate driver 62; a timing controller 63 controlling the source driver 61 and the gate driver 62; and a power circuit 64 supplying an electrical power to the source driver 61 and the gate driver 62.

The display region 60 is a region in which an image is displayed and in which the pixels 10 are arranged in a matrix so as to display an image. In addition, in FIG. 10, besides the display region 60 containing the pixels 10, a region corresponding to four pixels 10 is also separately shown by an enlarged view.

In the display region 60, source lines 71 are arranged in a row direction, gate lines 72 are also arranged in a column direction, and at positions at which the source lines 71 and the gate lines 72 intersect each other, the pixels 10 are arranged. Each pixel 10 includes a transistor 121 and a capacitor 122 together with the pixel electrode 20B and the liquid crystal layer 40. In each transistor 121, a source electrode is connected to the source line 71, a gate electrode is connected to the gate line 72, and a drain electrode is connected to the capacitor 122 and the pixel electrode 20B. Each source line 71 is connected to the source driver 61, and an image signal is supplied from the source driver 61. Each gate line 72 is connected to the gate driver 62, and a scanning signal is supplied from the gate driver 62.

The source driver 61 and the gate driver 62 select a specific pixel 10 among the pixels 10.

The timing controller 63 outputs, for example, an image signal (such as each of image signals of RGB corresponding to red, green, and blue) and a source driver control signal for controlling operation of the source driver 61 to the source driver 61. In addition, the timing controller 63 outputs, for example, a gate driver control signal for controlling operation of the gate driver 62 to the gate driver 62. As the source driver control signal, for example, there may be mentioned a horizontal synchronizing signal, a start pulse signal, or a clock signal for the source driver. As the gate driver control signal, for example, there may be mentioned a vertical synchronizing signal or a clock signal for the gate driver.

In this liquid crystal display device, when a drive voltage is applied between the first electrode (pixel electrode) 20B and the second electrode (counter electrode) 30B by the following procedure, an image is displayed. In particular, when a source driver control signal is inputted from the timing controller 63, based on an image signal inputted from the same timing controller 63, the source driver 61 supplies a specific image signal to a predetermined source line 71. In addition, when a gate driver control signal is inputted from the timing controller 63, the gate driver 62 sequentially supplies scanning signals to the gate lines 72 at predetermined timing. Accordingly, a pixel 10 which is located at an intersection between the source line 71 to which the image signal is supplied and the gate line 72 to which the scanning signal is supplied is selected, and a drive voltage is applied to the pixel 10.

Hereinafter, the present disclosure will be described with reference to an embodiment and examples.

### Embodiment 1

A liquid crystal display device (or liquid crystal display element) of a VA mode and a method for manufacturing a liquid crystal display device (or liquid crystal display element) according to Embodiment 1 of the present disclosure will be described. In Embodiment 1, the liquid crystal layer 40 includes the liquid crystal molecules 41 and further includes a polymerized high molecular compound (high molecular polymer compound). In addition, pretilts are provided to the liquid crystal molecules 41 by the polymerized high molecular compound (high molecular polymer compound) in contact with the alignment films 22 and 32. In this case, after the first alignment film 22 is formed on the first substrate 20, and the second alignment film 32 is formed on the second substrate 30, the first substrate 20 and the second substrate 30 are arranged so that the first alignment film 22 and the second alignment film 32 face each other, a pre-liquid crystal layer 40 containing the liquid crystal molecules 41 and a polymerizable compound (a polymerizable low molecule compound or a polymerizable high molecular compound, that is, an unpolymerized compound) is then sealed between the first alignment film 22 and the second alignment film 32, and the compound (unpolymerized compound) is polymerized so as to form the liquid crystal layer 40 from the pre-liquid crystal layer 40 and so as to provide pretilts to the liquid crystal molecules 41. In more particular, while the liquid crystal molecules are aligned by applying a predetermined electric field or magnetic field to the pre-liquid crystal layer, energy rays (such as ultraviolet rays) are irradiated, so that the compound (unpolymerized compound) is polymerized. As a result, the liquid crystal molecules 41 can be aligned in a predetermined direction (in particular, in an oblique direction) with respect to the pair of substrates (in particular, the TFT substrate 20 and the CF substrate 30). In addition, as described above, since pretilts can be provided to liquid crystal molecules 41 in the vicinities of the alignment films 22 and 32, and furthermore, the first alignment control sections 21 and the second alignment control sections 31 are formed in the first electrode 20B and the second electrode 30B, respectively, the response speed is increased, and the display properties are improved.

In addition, in the central region 51 of the overlapping area 50, the liquid crystal molecular group in the liquid crystal layer 40 is not in a twisted state. Hence, when a voltage is applied to the pair of the electrodes 20B and 30B, no time is necessary to eliminate the twist of the long axes of the liquid crystal molecular group, and the response properties can be further improved.

The liquid crystal layer 40 contains the liquid crystal molecules 41 each having negative dielectric anisotropy. For example, the liquid crystal molecule 41 has a rotation symmetric shape with respect to each of the long axis and the short axis as a central axis, which orthogonally intersect each other, and has negative dielectric anisotropy.

The liquid crystal molecules 41 can be classified into the liquid crystal molecules 41A held by the first alignment film 22 in the vicinity of the interface therewith, the liquid crystal molecules 41B held by the second alignment film 32 in the vicinity of the interface therewith, and liquid crystal molecules 41C other than those described above. The liquid crystal molecules 41C are located in a middle region in the thickness direction of the liquid crystal layer 40, and when a drive voltage is in an off state, the long axis direction (director) of the liquid crystal molecule 41C is arranged approximately perpendicular to the first substrate 20 and the second substrate 30. In this case, when the drive voltage is turned on, the liquid crystal molecule 41C is obliquely aligned so that the director thereof is parallel to the first substrate 20 and the second substrate 30. The behavior as described above is derived from the property in which in the liquid crystal molecule 41C, the dielectric constant in the long axis direction is lower than that in the short axis direction. Since the liquid crystal molecules 41A and 41B also have properties similar to that described above, in accordance with the change between on and off states of the drive voltage, fundamentally, behavior similar to that of the liquid crystal molecule 41C is performed. However, when the drive voltage is in an off state, the first pretilt angle θ1 is provided to the liquid crystal molecule 41A by the high molecular polymer compound, and the director thereof is inclined from the normal direction of the first substrate 20 and the second substrate 30. As in the case described above, the second pretilt angle θ2 is also provided to the liquid crystal molecule 41B by the high molecular polymer compound, and the director thereof is inclined from the normal direction of the first substrate 20 and the second substrate 30. Incidentally, the “held” indicates the state in which the alignment films 22 and 32 are not tightly adhered to the liquid crystal molecules 41A and 41C, respectively, but control the alignment of the liquid crystal molecules 41. In addition, if the direction (normal direction) perpendicular to the surface of the first substrate 20 and that of the second substrate 30 is represented by Z, as shown in FIG. 6, when the drive voltage is in an off state, the “pretilt angle θ(θ1, θ2) indicates an inclination angle of a director D of the liquid crystal molecule 41 (41A, 41B) with respect to the Z direction.

In the liquid crystal layer 40, the pretilt angles θ1 and θ2 both are larger than 0°. In this liquid crystal layer 40, although the pretilt angle θ1 may be equal to the pretilt angle θ2 (81=82) or may be different therefrom (θ1#θ2), in particular, the pretilt angle θ1 is preferably different from the pretilt angle θ2. Accordingly, the response speed to the drive voltage application is improved as compared to the case in which the pretilt angles θ1 and θ2 are both 0°, and in addition, the contrast approximately equivalent to that obtained when the pretilt angles θ1 and θ2 are both 0° can also be obtained. Therefore, while the response properties are improved, the transmission amount of light can be decreased when black display is performed, and the contrast can be improved. When the pretilt angle θ1 is made different from the pretilt angle θ2, the pretilt angle θ1 or the pretilt angle θ2, whichever is larger, is more preferably in a range of 1° to 4°. When a larger pretilt angle θ is set in the range described above, a particularly high effect can be obtained.

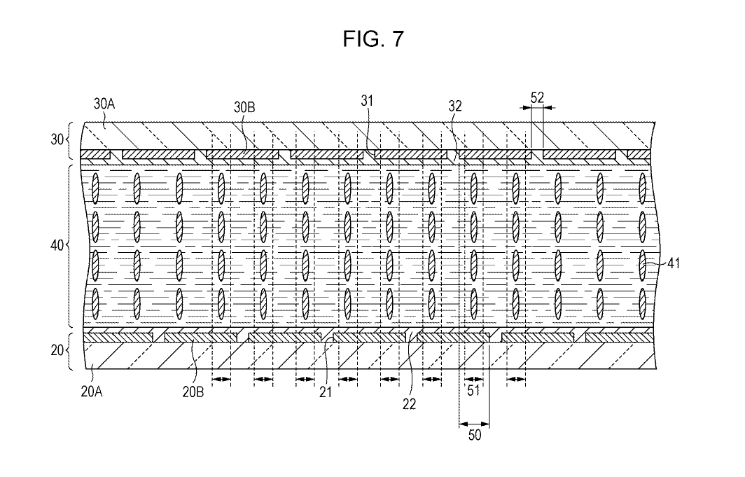

Next, a method for manufacturing the above liquid crystal display device (liquid crystal display element) will be described with reference to schematic partial cross-sectional views of a liquid crystal display device and the like shown in FIGS. 7, 8, and 9. For the sake of simplification, in FIGS. 7, 8, and 9, only one pixel region is shown.

First, the first alignment film 22 is formed on the surface of the first substrate (TFT substrate) 20, and the second alignment film 32 is also formed on the surface of the second substrate (CF substrate) 30.

In particular, first, the pixel electrodes 20B having predetermined first slit portions 21 are provided on the surface of the first substrate 20, for example, in a matrix to form the TFT substrate 20. In addition, the counter electrodes 30B having predetermined second slit portions 31 are provided on the color filter formed on the second substrate 30 to form the CF substrate 30.

Next, after an alignment film material is applied or printed on the TFT substrate 20 and the CF substrate 30 so as to cover the pixel electrodes 20 and the first slit portions 21 and the counter electrodes 30B and the second slit portions 31, respectively, a heat treatment is performed. As the temperature for the heat treatment, an optimal temperature conditions may be selected in consideration of an alignment film material to be used. Subsequently, if necessary, a treatment, such as rubbing, may also be performed. Accordingly, the first alignment film 22 and the second alignment film 32, each of which is a vertical alignment film, can be obtained.

Next, the TFT substrate 20 and the CF substrate 30 are arranged so that the alignment film 22 and the alignment film 32 face each other, and the pre-liquid crystal layer 40 containing the liquid crystal molecules 41 is sealed between the alignment film 22 and the alignment film 32. In particular, on one surface of the TFT substrate 20 or the CF substrate 30 on which the alignment film 22 or 32 is formed, respectively, spacer projections, such as plastic beads, for ensuring a cell gap are scattered, and a sealing portion is also printed using an epoxy adhesive or the like, for example, by a screen printing method. Subsequently, as shown in FIG. 7, the TFT substrate 20 and the CF substrate 30 are adhered to each other with the spacer projections and the sealing portion provided therebetween so that the alignment films 22 and 32 face each other, and a liquid crystal material containing the liquid crystal molecules 41 is charged between the above two substrates. Next, the sealing portion is cured by heating or the like, so that the liquid crystal material is sealed between the TFT substrate 20 and the CF substrate 30. FIG. 7 shows a cross-sectional structure of the pre-liquid crystal layer 40 sealed between the alignment film 22 and the alignment film 32.

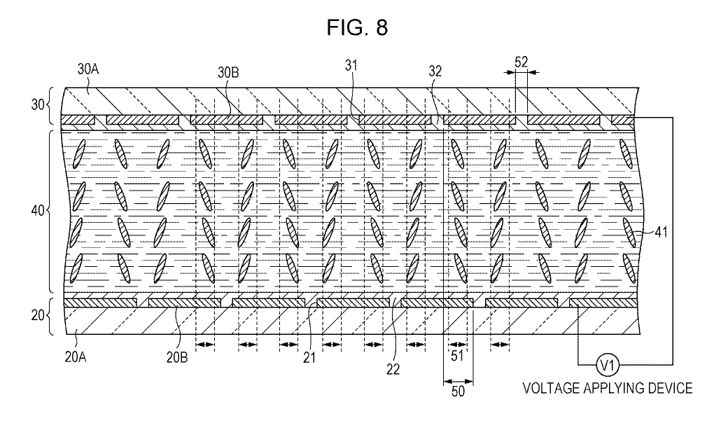

Next, as shown in FIG. 8, a voltage V1 is applied using a voltage applying device between the pixel electrode 20B and the counter electrode 30B. The voltage V1 is, for example, 3 to 30 volts. As a result, an electric field is generated in a direction at a predetermined angle with respect to the surface of the first substrate 20 and that of the second substrate 30, and the liquid crystal molecules 41 are aligned obliquely in a predetermined direction inclined from the normal direction of the first substrate 20 and that of the second substrate 30. That is, the azimuth angle (deviation angle) of each liquid crystal molecule 41 at this stage is specified by the intensity and the direction of the electric field and also by the composition and the structure of each of the first slit portion 21 and the second slit portion 31, and the polar angle (zenith angle) is specified by the intensity of the electric field and the composition and the structure of each of the first slit portion 21 and the second slit portion 31. In addition, the pretilt angles θ1 and θ2 provided to the liquid crystal molecules 41A held by the first alignment film 22 in the vicinity of the interface therewith and the liquid crystal molecules 41B held by the second alignment film 32 in the vicinity of the interface therewith, respectively, are approximately equal to each other. Therefore, the pretilt angles θ1 and θ2 of the liquid crystal molecules 41A and 41B, respectively, can be controlled by appropriately adjusting the voltage V1.

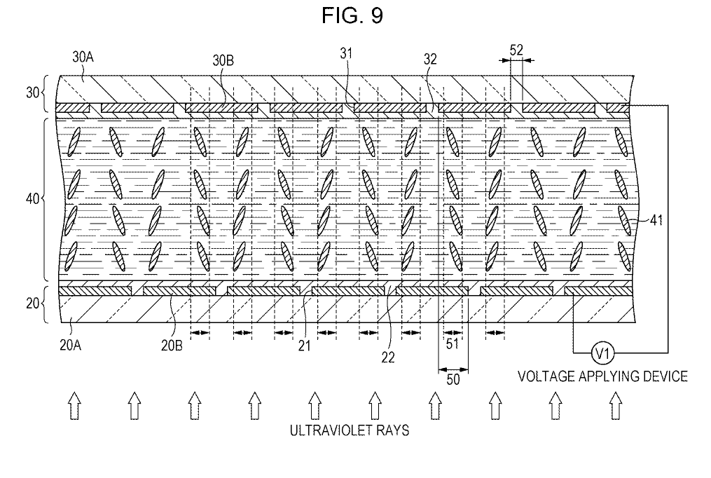

Furthermore, as shown in FIG. 9, in the state in which the voltage V1 is applied, for example, energy rays (in particular, ultraviolet rays) are irradiated to the pre-liquid crystal layer 40 from the outside of the TFT substrate 20. That is, ultraviolet rays are irradiated to the pre-liquid crystal layer while an electric field or a magnetic field is applied so as to align the liquid crystal molecules 41 in an oblique direction with respect to the surfaces of the substrates 20 and 30. Accordingly, the compound (unpolymerized compound) contained in the pre-liquid crystal layer 40 is polymerized, and the pretilt is provided to the liquid crystal molecules 41. As described above, the direction to which the liquid crystal molecules 41 should respond is memorized by the high molecular polymer compound, and the pretilts are provided to the liquid crystal molecules 41 in the vicinities of the alignment films 22 and 32. In addition, as a result, in a non-driving state, the pretilt angles θ1 and θ2 are provided to the liquid crystal molecules 41A and 41B, respectively, in the liquid crystal layer 40 located in the vicinities of the interfaces with the alignment films 22 and 32 by the high molecular polymer compound. As the ultraviolet rays, ultraviolet rays containing many light components having a wavelength in a range of approximately 295 to 365 nm are preferable. The reason for this is that when ultraviolet rays containing many light components in a shorter wavelength region than that described above are used, the liquid crystal molecules 41 may be may be degraded by photo-decomposition in some cases. In this embodiment, although ultraviolet rays are irradiated from the outside of the TFT substrate 20, irradiation may be performed from the outside of the CF substrate 30 and may also be performed from the outside of the TFT substrate 20 and that of the CF substrate 30. In this case, ultraviolet rays are preferably irradiated from a side of a substrate having higher transmittance. In addition, when ultraviolet rays are irradiated from the outside of the CF substrate 30, depending on a wavelength band of the ultraviolet rays, a polymerization reaction may not be easily performed in some cases since ultraviolet rays are absorbed with the color filter. For this reason, the irradiation is preferably performed from the outside of the TFT substrate 20 (side of the substrate having pixel electrodes).

In addition, in order to fully polymerize the compound (unpolymerized compound) contained in the pre-liquid crystal layer 40 and to decrease the amount of a remaining unpolymerized compound as small as possible, the irradiation time of energy rays (in particular, ultraviolet rays) is preferably set sufficiently long. In particular, as the amount of ultraviolet irradiation to the compound (unpolymerized compound) contained in the pre-liquid crystal layer 40, 1 to 20 J and preferably 5 to 10 J may be mentioned by way of example. When the amount of ultraviolet irradiation is excessive, the pre-liquid crystal layer and other organic substances may be damaged in some cases.

By the steps as described above, the liquid crystal display device (liquid crystal display element) shown in FIG. 1 can be completed.

In operation of the liquid crystal display device (liquid crystal display element), when a drive voltage is applied, in the selected pixel 10, the alignment state of the liquid crystal molecules 41 contained in the liquid crystal layer 40 is changed in accordance with the difference in electrical potential between the pixel electrode 20B and the counter electrode 30B. In particular, in the liquid crystal layer 40, when a drive voltage is applied to the state shown in FIG. 1 in which no drive voltage is applied, the liquid crystal molecules 41A and 41B located in the vicinities of the alignment films 22 and 23, respectively, go down in their own inclination directions, and in addition, their behaviors are propagated to the other liquid crystal molecules 41C. As a result, the liquid crystal molecules 41 respond so as to be approximately horizontal (parallel) with respect to the TFT substrate 20 and the CF substrate 30. Accordingly, optical properties of the liquid crystal layer 40 are changed, incident light on the liquid crystal display element is changed into modulated emission light, and gradation expression is performed based on this emission light, thereby displaying an image.

In a liquid crystal display element in which no pretilt treatment is performed and a liquid crystal display device including the same, even if alignment control sections, such as slit portions, for controlling the alignment of liquid crystal molecules are provided, when a drive voltage is applied, in a region apart from the alignment control section, liquid crystal molecules aligned in a direction perpendicular to the substrate go down so that the directors are aligned in arbitrary directions in an in-plane direction of the substrate. In the liquid crystal molecules which respond to a drive voltage as described above, the directions of the directors of the liquid crystal molecules are placed in a disordered state, and the alignment is disordered as a whole. Accordingly, the response speed is decreased, the response properties are degraded, and as a result, the display properties are disadvantageously degraded. In addition, when driving is performed such that an initial drive voltage is set higher than a drive voltage in a display state (overdrive driving), in the initial drive voltage application, liquid crystal molecules which respond thereto and liquid crystal molecules which hardly respond are both present, and between the above two types of liquid crystal molecules, a large difference in inclination of the director is generated. When the drive voltage in a display state is then applied, in the liquid crystal molecules which respond in the initial voltage drive application, before the behavior thereof is hardly propagated to the other liquid crystal molecules, the directors are inclined in accordance with the drive voltage in a display state, and this inclination is propagated to the other liquid crystal molecules. As a result, as the whole pixel, although the luminance in a display state is obtained in the initial drive voltage application, subsequently, the luminance decreases and again reaches the luminance in a display state. That is, when the overdrive driving is performed, an apparent response speed is increased as compared to the case in which no overdrive driving is performed; however, there has been a problem in that a sufficient display quality is not easily obtained. Incidentally, since these problems as described above hardly occur in a liquid crystal display element of an IPS mode or an FFS mode, it is believed that the above problems are particular in a VA mode liquid crystal display element.

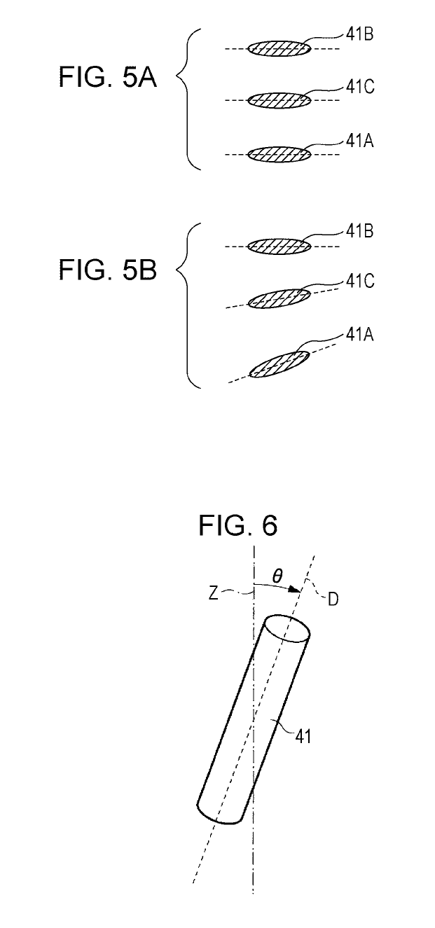

On the other hand, in the liquid crystal display device (liquid crystal display element) of Embodiment 1 and the method for manufacturing the same, the high molecular polymer compound described above provides the predetermined pretilt angles θ1 and θ2 to the liquid crystal molecules 41A and 41B, respectively. Accordingly, the problem in the case in which no pretilt treatment is performed is not likely to occur, the response speed to a drive voltage is significantly improved, and the display quality in the overdrive driving is also improved. Furthermore, since the first slit portions 21 and the second slit portions 31, each of which functions as the alignment control section, for controlling the alignment of the liquid crystal molecules 41 are provided in the TFT substrate 20 and CF substrate 30, respectively, the display properties, such as viewing angle properties, are ensured; hence, while excellent display properties are maintained, the response properties are improved, and the response speed is significantly improved. Furthermore, in the central region 51 of the overlapping area 50, the liquid crystal molecular group in the liquid crystal layer 40 is not in a twisted state. Therefore, when a voltage is applied between the electrodes 20B and 30B, no time is necessary to eliminate the twist of the long axes of the liquid crystal molecular group, and hence, the response properties can be further improved. In addition, the state in which the long axes of the liquid crystal molecular group are twisted is schematically shown in FIGS. 5A and 5B. The liquid crystal molecule 41B shown at a top position of each of FIGS. 5A and 5B indicates a liquid crystal molecule located in the vicinity of the second substrate, the liquid crystal molecule 41A shown at a bottom position of each of FIGS. 5A and 5B indicates a liquid crystal molecule located in the vicinity of the first substrate, and the liquid crystal molecule 41C shown at a middle position of each of FIGS. 5A and 5B indicates a liquid crystal molecule located at a middle position between the first substrate and the second substrate. In addition, the dotted line intersecting each liquid crystal molecule represents the long axis thereof.

In the state shown in FIG. 5A, the liquid crystal molecular group in the liquid crystal layer 40 is not in a twisted state. On the other hand, in the state shown in FIG. 5B, the liquid crystal molecular group in the liquid crystal layer 40 is in a twisted state.

In addition, in a related method for manufacturing a liquid crystal display (photo-alignment technique), the alignment film is formed by irradiating a precursor film containing a predetermined high molecular material provided on a substrate surface with linearly polarized light or light (hereinafter, referred to as “oblique light”) in a direction oblique to the substrate surface, and hence a pretilt treatment is performed. Accordingly, when the alignment film is formed, there has been a problem in that a large-scale light irradiation apparatus such as an apparatus of irradiating parallel beams of linearly polarized light in an oblique direction is necessary. In addition, for the formation of pixels having multi-domains to realize a wider viewing angle, masks are necessary, and in addition, a manufacturing process is disadvantageously complicated. In particular, when the alignment film is formed using oblique light, if structural materials, such as spacers, or irregularities are present on the substrate, regions to which no oblique light reaches are generated due to shadows formed by the structure materials or the like, and in the regions described above, desired alignment control for liquid crystal molecules is difficult to perform. In this case, for example, when oblique light is irradiated using a photomask in order to provide multi-domains in the pixel, a pixel design in which light can be appropriately guided may be necessary. That is, when the alignment film is formed using oblique light, there has been a problem in that high definition pixel formation is difficult to perform.

Furthermore, when a cross-linkable high molecular compound is used as the high molecular material in the related photo-alignment technique, since cross-linkable functional groups or polymerizable functional groups included in the cross-linkable high molecular compound in a precursor film are directed in random directions by the thermal motion, the probability of decreasing physical distances between the cross-linkable functional groups or between the polymerizable functional group is decreased. In addition, when random light (unpolarized light) is irradiated, although a reaction occurs since the physical distances between the cross-linkable functional groups or between the polymerizable functional groups are decreased, in cross-linkable functional groups or polymerizable functional groups which react when irradiated with linearly polarized light, a polarized light direction and a direction of a reactive site are necessarily aligned in a predetermined direction. In addition, compared to vertical light, in the case of oblique light, the amount of irradiation per unit area is decreased corresponding to an increase in an irradiated area. That is, the rate of the cross-linkable functional group or the polymerizable functional group which reacts by linearly polarized light or oblique light is lower than the case in which random light (unpolarized light) is irradiated in a direction perpendicular to the substrate surface. Therefore, a cross-linking density (degree of cross-linking) in the formed alignment film tends to be low.

On the other hand, in Embodiment 1, in the state in which the unpolymerized compound is contained in the pre-liquid crystal layer 40, the pre-liquid crystal layer 40 is sealed between the alignment film 22 and the alignment film 32. Subsequently, by applying a voltage to the pre-liquid crystal layer 40, the liquid crystal molecules 41 are aligned in a predetermined direction, and at the same time, while directions of terminal-structural portions of side chains to the substrate or the electrode are specified by the liquid crystal molecules 41, the unpolymerized compound in the pre-liquid crystal layer 40 is polymerized. As described above, the pretilt angles θ1 and θ2 can be provided to the liquid crystal molecules 41A and 41B, respectively, by the high molecular polymer compound. That is, according to the liquid crystal display device (liquid crystal display element) of Embodiment 1 and the method for manufacturing the same, without using a large-scale apparatus, the response properties can be easily improved. Furthermore, when the unpolymerized compound is polymerized, since the pretilt angle θ can be provided to the liquid crystal molecules 41 without depending on the irradiation direction of ultraviolet rays, high definition pixel formation can be performed. In addition, even if driving is performed for a long time, since a polymer structure is not likely to be newly formed during the driving, the pretilt angles θ1 and θ2 of the liquid crystal molecules 41A and 41B, respectively, are maintained as those in the manufacturing state, and hence the reliability can also be improved.

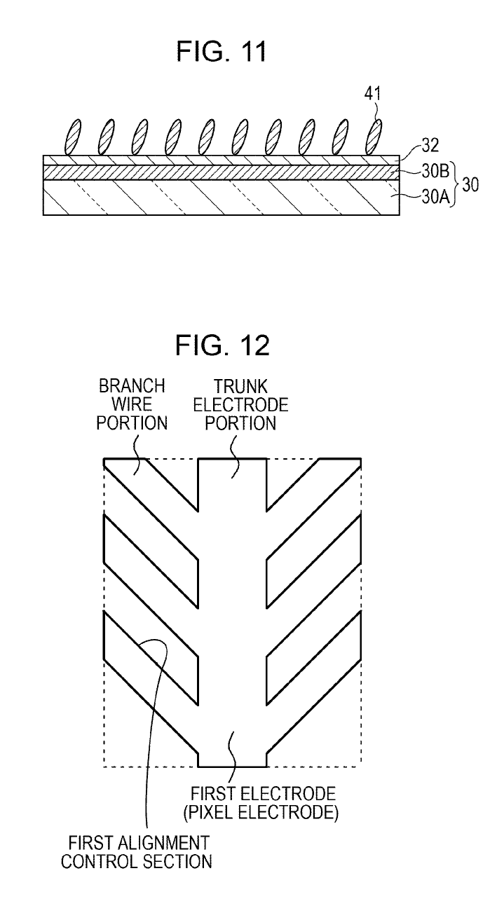

In addition, in Embodiment 1 in which after the pre-liquid crystal layer 40 is sealed, the pretilt treatment is performed by polymerization of the unpolymerized compound contained in the pre-liquid crystal layer 40, by the first slit portions 21 and the second slit portions 31 for controlling the alignment of the liquid crystal molecules 41 in the vicinities of the alignment films 22 and 32, the pretilt is provided in accordance with the alignment direction of the liquid crystal molecules 41 in the driving. Accordingly, as shown in FIG. 11, since the directions of the pretilts of the liquid crystal molecules 41 are likely to be aligned, an order parameter is increased (closed to 1). Hence, when the liquid crystal display element is driven, since the liquid crystal molecules 41 uniformly behave, the transmittance is continuously increased.

In addition, in Example 1, although the viewing angle properties are improved by providing the first slit portions 21 and the second slit portions 31 for alignment division, Example 1 is not limited thereto. For example, projections each functioning as an alignment control section may be provided on the pixel electrode 20B instead of providing the first slit portions 21. By providing the projections as described above, an effect similar to that obtained by providing the first slit portions 21 can also be obtained.

Furthermore, projections each functioning as an alignment control section may be further provided on the counter electrode 30B on the CF substrate 30. In this case, the projections on the TFT substrate 20 and the projections on the CF substrate 30 are disposed so as not to face each other between the substrates. In addition, by providing the projections as described above, an effect similar to that described above can also be obtained.

### Example 1

Example 1 of the present disclosure relates to a liquid crystal display device (liquid crystal display element) and a method for manufacturing the same. In Example 1, the liquid crystal display device (liquid crystal display element) shown in FIG. 1 was formed by the following procedure.

First, the TFT substrate 20 and the CF substrate 30 were prepared. As the TFT substrate 20, a substrate was used which was formed of a 0.7 mm-thick glass substrate 20A and the pixel electrodes 20B of ITO each having a slit pattern provided on one surface thereof. In the slit pattern, the width and the pitch of the first slit portion 21 were 5 μm and 65 μm, respectively, and the width of the first electrode 20B in which the first slit portions 21 were formed was 60 μm, and the space between the first electrodes 20B was 5 μm. In addition, as the counter substrate 30, a substrate was used which was formed of a 0.7 mm-thick glass substrate 30A and the counter electrodes 30B of ITO each having a slit pattern provided thereon. In the slit pattern, the width and the pitch of the second slit portion 31 were 5 μm and 65 μm, respectively, and the width of the second electrode 30B in which the second slit portions 31 were formed was 60 μm, and the space between the second electrodes 30B was 5 μm. By the slit patterns formed in the pixel electrode 20B and the counter electrode 30B, an oblique electric field is applied between the TFT substrate 20 and the CF substrate 30. Subsequently, 3.5-μm spacer projections were formed on the TFT substrate 20. In addition, as the slit pattern, the slit patterns shown in FIGS. 3A and 3B were used.

Subsequently, after a commercially available vertical alignment film material (AL1H659, manufactured by JSR Corp.) was applied to each of the TFT substrate 20 and the CF substrate 30 using a spin coater, a coated film was dried using a hot plate at 80° C. for 80 seconds. Then, the TFT substrate 20 and the CF substrate 30 were heated in an oven at 200° C. for 1 hour in a nitrogen gas atmosphere. Accordingly, the alignment films 22 and 32 each having a thickness of 90 nm on the pixel electrode 20B and the counter electrode 30B, respectively, were formed.

Next, an ultraviolet curable resin containing silica particles having a grain diameter of 3.5 μm was applied along the periphery of a pixel portion on the CF substrate 30 to form a sealing portion, and in a region surrounded thereby, a mixture of a liquid material formed of MLC-7029 (manufactured by Merck KGaA), which was a negative type liquid crystal, and an unpolymerized compound formed of acrylic monomer LC242 [shown by the formula (I-6)] was charged by dripping. In addition, a mass ratio of the liquid crystal material/the unpolymerized compound of the mixture was set to 100/0.3. Subsequently, the TFT substrate 20 and the CF substrate 30 are adhered to each other so that a central line of the pixel electrode 20B and the second slit portion 31 of the counter electrode 30B face each other, and the sealing portion was then cured. Next, heating was performed using an oven at 120° C. for 1 hour, so that the sealing portion was fully cured. Thereby, the pre-liquid crystal layer 40 is sealed, and the liquid crystal cell was completed.

Next, in the state in which a square-wave alternating electric field (60 Hz) having an effective voltage of 4 volts was applied to the liquid crystal cell thus formed, uniform ultraviolet rays of 500 mJ (measured at a wavelength of 365 nm) were irradiated, and the unpolymerized compound contained in the pre-liquid crystal layer 40 was polymerized, thereby forming the high molecular polymer compound. Accordingly, the liquid crystal display device (liquid crystal display element) shown in FIG. 1 was completed in which the liquid crystal molecules 41A and 41B located at the side of the TFT substrate 20 and at the side of the CF substrate 30, respectively, had pretilts. Finally, a pair of polarizers was adhered outside the liquid crystal display device so that their absorption axes orthogonally intersected each other.

The liquid crystal display device obtained as described above is called a liquid crystal display device of Example 1A.

Except that an unpolymerized compound shown by the formula (I-1) was used, a liquid crystal display device was formed in a manner similar to that of Example 1. The liquid crystal display device thus obtained is called a liquid crystal display device of Example 1B.

As Comparative Example 1, as shown in FIG. 12, a liquid crystal display device was manufactured in which a first electrode (pixel electrode) of a first substrate (TFT substrate) had a trunk electrode portion having a width of 8 μm and branch wire portions (width: 4 μm, space between the branch wire portions: 4 μm) extending from the trunk electrode portion in an obliquely upward direction, and in which no slit portions were provided in a second electrode (counter electrode) of a second substrate (CF substrate), that is, a solid electrode was formed. In addition, the composition and the structure of the liquid crystal display device were the same as those of Example 1A except the composition and the structure of each of the first electrode and the second electrode.

A response time, the first pretilt angle θ1, and the second pretilt angle θ2 of each of the liquid crystal display devices (liquid crystal display elements) of Example 1A, Example 1B, Comparative Example 1, and Example 2, which will be described later, were measured. Although the results are shown in the following Table, the first pretilt angle θ1 was equal to the second pretilt angle θ2. Hence, in Table, the first pretilt angle θ1 and the second pretilt angle θ2 are collectively shown as a pretilt angle θ. When the response time was measured, by using LCD5200 (manufactured by Otsuka Electronics Co., Ltd.) as a measuring apparatus, a drive voltage (7.5 volts) was applied between the pixel electrode 20B and the counter electrode 30B, and a time necessary for the change in the luminance of a gradation corresponding to the drive voltage from 10% to 90% was measured. In addition, when the pretilt angle θ of the liquid crystal molecules 41 was investigated, measurement was performed by a crystal rotation method using He—Ne laser beams in accordance with a common method (method by T. J. Scheffer et al., in J. Appl. Phys., vol. 19, p. 2013, 1980). In addition, as described above and as shown in FIG. 6, when a direction (normal direction) perpendicular to the surface of each of the glass substrates 20A and 30A is represented by Z, the pretilt angle θ is an inclination angle of the director D of the liquid crystal molecule 41 (41A, 41B) with respect to the Z direction when the drive voltage is in an off state.

TABLE

| | Pretilt angle θ (°) | Response time (ms) |
|---|---|---|
| Example 1A | 2.0 | 7.4 |
| Example 1B | 2.7 | 3.2 |
| Comparative | 2.1 | 18.7 |
| Example 1 | | |
| Example 2 | 3.0 | 12.1 |

As described above, in Example 1, in the state in which the pre-liquid crystal layer 40 is provided, the compound contained in the pre-liquid crystal layer 40 is polymerized so that the high molecular polymer compound contained in the liquid crystal layer 40 provides the pretilt angle θ to the liquid crystal molecules 41 in the vicinity thereof. In addition, since the first alignment control sections 21 and the second alignment control sections 31 are formed in the first electrode 20B and the second electrode 30B, respectively, the response speed can be significantly improved. In this case, it was confirmed that although a large-scale apparatus was not used, the pretilt could be provided to the liquid crystal molecules 41A and 41B. Furthermore, in the central region 51 of the overlapping area 50, the long axes of the liquid crystal molecular group in the liquid crystal layer 40 were located approximately in the same imaginary plane. In other words, the variation in azimuth direction (deviation angle) of the liquid crystal molecular group in the liquid crystal layer 40 was ±5°. That is, in the central region 51 of the overlapping area 50, the liquid crystal molecular group in the liquid crystal layer 40 was not in a twisted state. Hence, when a voltage was applied to the pair of the electrodes 20B and 30B, no time was necessary to eliminate the twist of the long axes of the liquid crystal molecular group, and hence, the response properties could be further improved. Furthermore, since the variation in azimuth angle (deviation angle) of the liquid crystal molecular group in the liquid crystal layer 40 is within ±5°, disorder in alignment caused by various wires (source lines, gate lines, and the like) can be controlled (that is, disorder of alignment can be suppressed), and the transmittance can be improved.

### Example 2

Example 2 is a modification of Example 1. In Example 1, while the liquid crystal molecules were aligned by applying a predetermined electric field to the pre-liquid crystal layer, by irradiation of energy rays, the compound (unpolymerized compound) was polymerized. On the other hand, in Example 2, while the liquid crystal molecules were aligned by applying a predetermined electric field to the pre-liquid crystal layer, the compound (unpolymerized compound) was polymerized by heating.

In Example 2, an unpolymerized compound shown by the formula (I-19) was used. Except for the above point, a liquid crystal display device was formed in a manner similar to that of Example 1. Measurement results of the response time, the first pretilt angle θ1, and the second pretilt angle θ2 of the liquid crystal display device thus obtained are shown in Table.

Although the present disclosure has been described with reference to preferred embodiments and examples, the present disclosure is not necessarily limited to the embodiments and the like and may be variously modified, and in addition, the composition, the structure, and the arrangement of each of the first alignment control section and the second alignment control section may be appropriately modified. For example, in the embodiments and examples, although the VA mode liquid crystal display device (liquid crystal display element) has been described, the present disclosure in not limited thereto and may also be applied to other display modes, such as an ECB mode (horizontally aligned mode of positive liquid crystal without a twisted structure), an IPS (In Plane Switching) mode, an FFS (Fringe Field Switching) mode, and an OCB (Optically Compensated Bend) mode. In this case, an effect similar to that described above can also be obtained. However, compared to the case in which no pretilt treatment is performed, in the present disclosure, a significantly higher effect of improving response properties can be obtained in a VA mode than that in an IPS mode and an FFS mode.

In addition, in the embodiments and examples, although the transmission type liquid crystal display device (liquid crystal display element) has been exclusively described, the present disclosure is not necessarily limited to the transmission type and may also be applied to a reflection type. When the reflection type is formed, the pixel electrode is formed of an electrode material, such as aluminum, having light reflectivity.

The present disclosure contains subject matter related to that disclosed in Japanese Priority Patent Application JP 2011-063674 filed in the Japan Patent Office on Mar. 23, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a first substrate;
a second substrate; and
a plurality of arranged pixels including:
first electrodes provided on a facing surface of the first substrate facing the second substrate;
first alignment control sections provided in the first electrodes;
a first alignment film covering the first electrodes, the first alignment control sections, and the facing surface of the first substrate;
second electrodes provided on a facing surface of the second substrate facing the first substrate;
second alignment control sections provided in the second electrodes;
a second alignment film covering the second electrodes, the second alignment control sections, and the facing surface of the second substrate; and
a liquid crystal layer which is provided between the first alignment film and the second alignment film and which contains liquid crystal molecules,
wherein the liquid crystal layer further contains a polymerized high molecular compound, and
the polymerized high molecular compound in contact with the alignment films provides pretilts to the liquid crystal molecules.

2. The liquid crystal display device according to claim 1,
wherein in each pixel, in a central region of an overlapping area in which a projection image of a region surrounded by a border of each first electrode and each first alignment control section and a projection image of a region surrounded by a border of each second electrode and each second alignment control section are overlapped with each other, long axes of a liquid crystal molecular group in the liquid crystal layer are located approximately in the same imaginary plane.

3. The liquid crystal display device according to claim 1,
wherein the liquid crystal molecules have negative dielectric anisotropy.

4. The liquid crystal display device according to claim 1,
wherein the high molecular compound includes a high molecular compound containing at least one selected from the group consisting of an acrylic group, a methacrylic group, a vinyl group, a vinyloxy group, a propenyl ether group, an epoxy group, an oxetane group, and a styryl group.

5. The liquid crystal display device according to claim 1,
wherein the high molecular compound includes a high molecular compound containing a mesogenic group.

6. A method for manufacturing a liquid crystal display device which includes:
a first substrate;
a second substrate, and
a plurality of arranged pixels having:
first electrodes provided on a facing surface of the first substrate facing the second substrate;
first alignment control sections provided in the first electrodes;
a first alignment film covering the first electrodes, the first alignment control sections, and the facing surface of the first substrate;
second electrodes provided on a facing surface of the second substrate facing the first substrate;
second alignment control sections provided in the second electrodes;
a second alignment film covering the second electrodes, the second alignment control sections, and the facing surface of the second substrate; and
a liquid crystal layer which is provided between the first alignment film and the second alignment film and which contains liquid crystal molecules, the method comprising:
forming the first alignment film on the first substrate;
forming the second alignment film on the second substrate;
arranging the first substrate and the second substrate so that the first alignment film and the second alignment film face each other;
sealing a pre-liquid crystal layer containing a polymerizable compound and the liquid crystal molecules between the first alignment film and the second alignment film; and
polymerizing the polymerizable compound to form the liquid crystal layer from the pre-liquid crystal layer and to provide pretilts to the liquid crystal molecules.

7. The method for manufacturing a liquid crystal display device according to claim 6,
wherein while the liquid crystal molecules are aligned by applying a predetermined electric field to the pre-liquid crystal layer, the compound is polymerized by irradiation of energy rays.

8. The method for manufacturing a liquid crystal display device according to claim 6,
wherein while the liquid crystal molecules are aligned by applying a predetermined electric field to the pre-liquid crystal layer, the compound is polymerized by heating.
